(19) United States
(12) Patent Application Publication
(10) Pub. No.: US 2009/0085888 A1
(43) Pub. Date: Apr. 2, 2009

(54) Resistive multi-touch panel and detecting method thereof

(75) Inventor: Chih-Chang Ho, Taoyuan County (TW)

Correspondence Address: BACON & THOMAS, PLLC, 625 SLATERS LANE, FOURTH FLOOR, ALEXANDRIA, VA, 22314-1176, US

(73) Assignee: HIMARK TECHNOLOGY INC., HSIN-CHU City (TW)

(21) Appl. No.: 12/071,955

(22) Filed: Feb. 28, 2008

(30) Foreign Application Priority Data
Oct. 2, 2007 (TW) 096136948

(51) Int. Cl. G06F 3/045

(52) U.S. Cl. 345/174

(57) ABSTRACT

The present invention provides a resistive multi-touch panel and its method that comprises a first touch panel module, a second touch panel module, at least one touch sensing device and at least one coordinate acquiring device. Therein, the first touch panel module includes a plurality of first planar resistors independently arranged. The second touch panel module includes a plurality of second planar resistors, also independently arranged. The second touch panel module is positioned below the first touch panel module while an arrangement direction of the second planar resistors differs from an arrangement direction of the first second planar resistors. Thereupon, the resistive multi-touch panel employs the plurality of first planar resistors and the plurality of second planar resistors to achieve multi-touch effect to overcome the defect of the conventional resistive touch panel that merely allows the single-touch input at a time.

### BACKGROUND OF THE INVENTION

1. Technical Field

The present invention relates to resistive touch panels and, more particularly, to a resistive multi-touch panel.

2. Description of Related Art

In the market of consumer electronic products nowadays, touch panels have been widely used in various portable electronic products, such as PDAs (personal digital assistants), mobile phones, notebooks and tablet PCs (personal computers) or ATM (Automatic Teller Machine) as an interface for data communication. Besides, when the trend is towards lightweight and compactness for the electronic devices, there is no extra room for accommodating traditional input devices, such as keyboards and mice, on such devices. Especially, due to the need of tablet PC featuring the humanized design, the touch panel has become one of the crucial components in the industry. The touch panel does not only satisfy the requirement for multi-level menu, but also provides a humanist operation for the functions and handwriting input as well as a keyboard and a mouse. Moreover, the characteristic of the touch panel that integrates input and output functions into a single interface (screen) make it be much more superior to other traditional input devices.

The conventional touch panels can be classified into five types, which are the optics type, the ultrasonic type, infrared type, the capacitive types, and the resistive type. In the perspective of touch control technology, an optics touch panel employs light-beam interruption to actuate sensing effect, and is typically applied to high-level products. Since the optics touch panel requires higher costs while presenting inferior resolution, it is less popularized. An ultrasonic touch panel implements sound waves to induce sensing effect, and has the disadvantage of being subject to external interference. Besides, as only relatively soft materials can be used as a touch media of the ultrasonic-type touch panel, errors may liable to happen due to interference such as water drop and greasiness. Therefore, the ultrasonic-type touch panel is only adaptive to a large-size product, such as a public inquiring computer. A capacitive touch panel has the advantages of waterproofing, scraping resistance, and high transmittance and therefore it is applicable to various terminal devices. However, the capacitive touch panel also has some disadvantages. For instance, the fabrication of the capacitive touch panel is relatively complex since many layers of thin films need to be coated thereon. Thus, the manufacturing costs thereof are relatively high and the capacitive touch panel is presently unsuitable to small-size products. On the other hand, a resistive touch panel uses a voltage detecting method to achieve sensing effect. In such technology, ITO (Indium Tin Oxide) glass and ITO PET film are taken as main materials and coated with transparent electrodes at upper and lower surfaces thereof. Dot spacers thrn are provided between each two adjacent transparent electrodes, when a finger, a stylus or another object exerts a force to the electrode at the upper surface, the electrodes at the upper and lower surfaces is conducted to generate a potential difference, so that a coordinate location of the exerting object is further calculated and shown on a display. Such resistive touch panel is most widely adopted due to its low costs and thin thickness.

Please refer to FIG. 1 for internal components of a conventional resistive touch panel. The resistive touch panel 1 is composed of stacking an X layer 11 and a Y layer 12. The X layer 11 and the Y layer 12 are both planar resistors and normally disconnected with each other. When a user exerts a force to press the resistive touch panel 1 at a touch point, the X layer 11 and the Y layer 12 contact mutually at a position corresponding to the touch point. For example, when the user presses the resistive touch panel, a point P1 at the Y layer 12 corresponding to the touch point is in contact with a point P2 at the X layer 11 and corresponding to the touch point.

Now referring to FIG. 2, an equivalent circuit diagram of the conventional resistive touch panel is provided. In the equivalent circuit 21 of the resistive touch panel, an equivalent resistance R_{M} exists between the X layer and the Y layer. As described above, the X layer and the Y layer are normally disconnected with each other. At this time, open circuit is between the X layer and the Y layer. In another word, the equivalent resistance R_{M} existing between the X layer and the Y layer is of infinity. When an external force acts on the resistive touch panel, the X layer and the Y layer contact mutually and the closed circuit is formed therebeween so that the equivalent resistance R_{M} is much smaller than it at a normal state. To sum up, in the equivalent circuit 21 of the resistive touch panel, the equivalent resistance R_{M} is subject to an external force, and determined by the condition of contacting the X layer and the Y layer. Further, as previously discussed, the X layer and the Y layer are both planar resistors. When an external force presses the resistive touch panel to allow the point P1 at the Y layer to contact the point P2 at the X layer, the equivalent resistances of the X layer are two resistances R_{X0} and R_{X1} coupled to the point P2. Therein, the two equivalent resistances R_{X0} and R_{X1} are determined by where the point P2 is positioned at the X layer. Besides, the two equivalent resistances R_{X0} and R_{X1} is only changed based on an X coordinate location of the point P2 without following a Y coordinate location of the point P2. Similarly, equivalent resistances of the Y layer are two resistances R_{Y0} and R_{Y1} serially connected with the point P1. The two equivalent resistances R_{Y0} and R_{Y1} are determined by where the point P1 is positioned at the Y layer. Moreover, the two equivalent resistances R_{Y0} and R_{Y1} is only changed based on a Y coordinate location of the point P1 without following an X coordinate location of the point P1. Thereupon, when an external force presses the resistive touch panel at a touch point to enable the point P1 at the Y layer 12 corresponding to the touch point to be in contact with the point P2 at the X layer 11 corresponding to the touch point, the equivalent circuit as shown in FIG. 2 is established.

However, the conventional resistive touch panel can only receive one touch point at one time. Namely, the closed circuit has been established between the planar resistors of the X layer and the Y layer. When another touch point is to be input, the current touch point has to be released, resulting in forming the open circuit between the X layer and the Y layer, and then another touch point can be accepted. In other words, the conventional resistive touch panel is incapable of recognizing multi-touch input. Thus, multi-touch input executed to a resistive touch panel is an important issue.

To satisfy the requirement of executing multi-touch input to a resistive touch panel, the inventor(s) of the present invention, on the basis of the knowledge and experience thereof, herein discloses a resistive multi-touch panel and a detecting method thereof in the present invention.

### SUMMARY OF THE INVENTION

The present invention has been accomplished under these circumstances in view. It is one objective of the present invention to provide a resistive touch panel, and more particularly, a resistive multi-touch panel and a detecting method thereof.

To achieve these and other objectives of the present invention, the resistive multi-touch panel primarily comprises a first touch panel module, a second touch panel module, at least one touch sensing device and at least one coordinate acquiring device. Therein, the first touch panel module includes a plurality of first planar resistors independently arranged. The second touch panel module includes a plurality of second planar resistors also independently arranged. The second touch panel module is positioned below the first touch panel module while the arrangement direction of the second planar resistors differ from the arrangement direction the first planar resistors. The touch sensing device is provided for detecting at least one touch point between the first touch panel module and the second touch panel module to output at least one first touch signal according to a variation of at least one of the first planar resistors and output at least one second touch signal according to a variation of at least one of the second planar resistors. The coordinate acquiring device outputs a position corresponding to the touch point according to the first touch signal and the second touch signal that mutually correspond to each other.

To achieve these and other objectives of the present invention, the detecting method of the resistive multi-touch panel comprises following steps:

a. providing a first touch panel module that includes a plurality of first planar resistors independently arranged;

b. providing a second touch panel module that includes a plurality of second planar resistors independently arranged, wherein the second touch panel module is positioned below the first touch panel module while the arrangement direction of the second planar resistors differ from the arrangement direction of the first planar resistors;

c. providing at least one external force to form at least one touch point between the first touch panel module and the second touch panel module;

d. detecting a variation of at least one of the first planar resistors at the at least one touch point to output at least one first touch signal;

e. detecting a variation of at least one of the second planar resistors at the at least one touch point to output at least one second touch signal; and

f. outputting a position corresponding to the touch point according to the first touch signal and the second touch signal that mutually correspond to each other.

Thereupon, the resistive multi-touch panel and the detecting method thereof disclosed in the present invention employ the plurality of first planar resistors and the plurality of second planar resistors to achieve multi-touch effect so as to overcome the defect of the conventional resistive touch panel that merely accepts a single-touch input at a time.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a schematic drawing showing internal components of a conventional resistive touch panel;

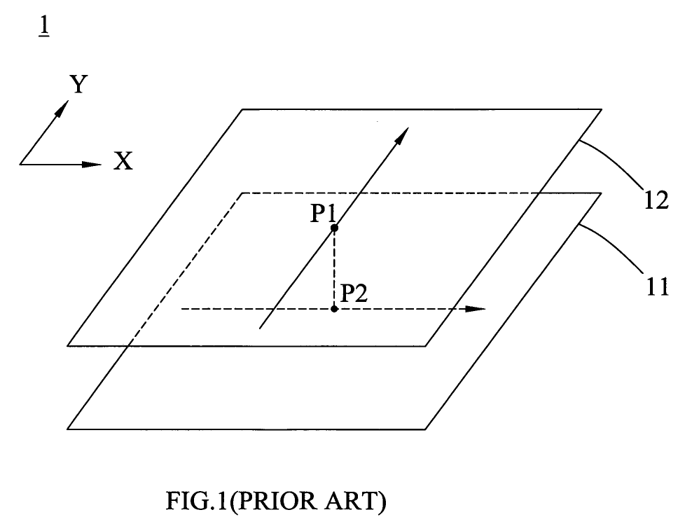

FIG. 2 is an equivalent circuit diagram of the conventional resistive touch panel;

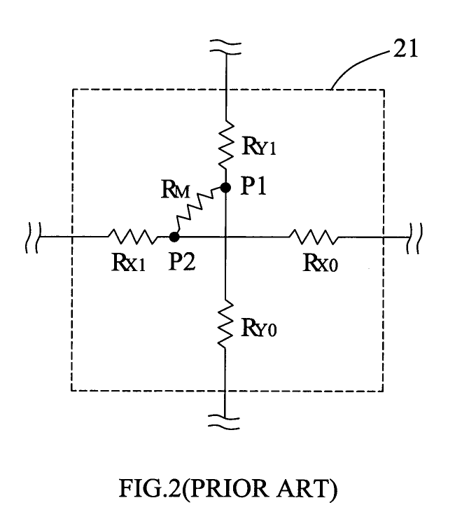

FIG. 3 is a schematic drawing showing a resistive multi-touch panel of the present invention;

FIG. 4 is a flowchart of a detecting method of the resistive multi-touch panel of the present invention;

FIG. 5 is a schematic drawing showing the resistive multi-touch panel according to a first embodiment of the present invention; and

FIG. 6 is a schematic drawing showing the resistive multi-touch panel according to a second embodiment of the present invention.

### DETAILED DESCRIPTION OF THE PREFERRED EMBODIMENT

For further illustrating the above-mentioned objectives, features and advantages of the resistive multi-touch panel and the detecting method thereof disclosed in the present invention, some preferable embodiments will be provided in the following detailed description in conjunction with the related drawings wherein similar components are allotted with the same notations.

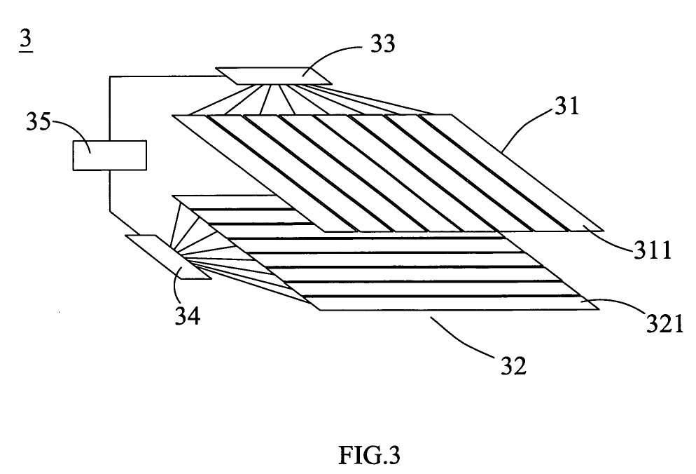

Please refer to FIG. 3 for the schematic diagram of a resistive multi-touch panel of the present invention. Therein, the resistive multi-touch panel 3 comprises a first touch panel module 31, a second touch panel module 32, a first touch sensing device 33, a second touch sensing device 34 and a coordinate acquiring device 35. The first touch panel module 31 includes a plurality of first planar resistors 311, independently arranged. The second touch panel module 32 includes a plurality of second planar resistors 321 independently arranged. The second touch panel module 32 is positioned below the first touch panel module 31 while the arrangement direction of the second planar resistors 321 differ from the arrangement direction of the first planar resistors 311. The first touch sensing device 33 and the second touch sensing device 34 are provided for detecting at least one touch point between the first touch panel module 31 and the second touch panel module 32 to output at least one first touch signal from the first touch sensing device 33 according to a variation of at least one of the first planar resistors 311 and output at least one second touch signal from the second touch sensing device 34 according to a variation of at least one of the second planar resistors 321. The coordinate acquiring device 35 outputs a position corresponding to the touch point according to the first touch signal and the second touch signal that are mutually corresponding.

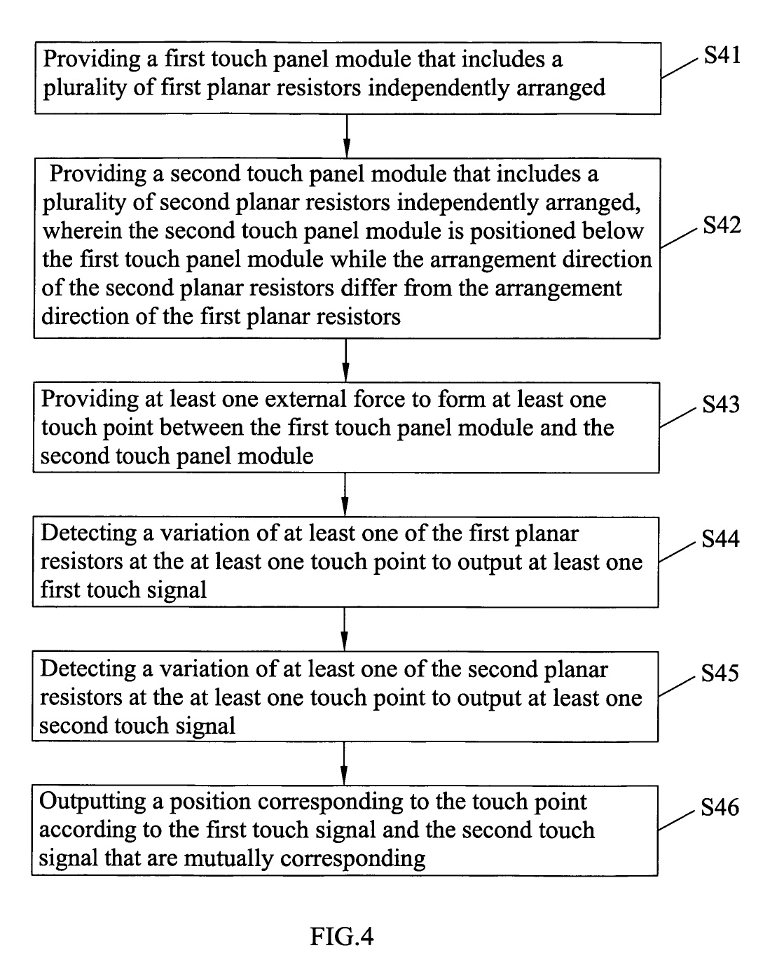

Please refer to FIG. 4 for a flowchart of the detecting method of the resistive multi-touch panel of the present invention, which comprises following steps:

Step S41: Providing a first touch panel module that includes a plurality of first planar resistors independently arranged;

Step S42: Providing a second touch panel module that includes a plurality of second planar resistors independently arranged, wherein the second touch panel module is positioned below the first touch panel module while the arrangement direction of the second planar resistors differ from the arrangement direction of the first planar resistors;

Step S43: Providing at least one external force to form at least one touch point between the first touch panel module and the second touch panel module;

Step S44: Detecting a variation of at least one of the first planar resistors at the at least one touch point to output at least one first touch signal;

Step S45: Detecting a variation of at least one of the second planar resistors at the at least one touch point to output at least one second touch signal; and

Step S46: Outputting a position corresponding to the touch point according to the first touch signal and the second touch signal that are mutually corresponding.

In the aforementioned resistive multi-touch panel and the detecting method thereof, the first touch panel module 31 and the second touch panel module 32 are preferably installed as perpendicular to each other. Further, each of the first planar resistors 311 of the first touch panel module 31 has a constant external voltage while each of the second planar resistors 321 of the second touch panel module 32 has a constant external voltage. In addition, the first touch sensing device 33 or the second touch sensing device 34 further comprises a determining mechanism for determining whether the touch point is effective. The variation of the first planar resistor 311 or the second planar resistor 321 generally refers to a voltage variation. In an alternative embodiment, the first touch sensing device 33 and the second touch sensing device 34 can be integrated into a single device. Besides, the generated position is typically outputted directly by taking the first touch panel module 31 or the second touch panel module 32 as a coordinate. Alternatively, the generated position can be outputted by converting the coordinate of the first planar resistors 311 or the second planar resistors 321 into the coordinate of the first touch panel module 31 or the second touch panel module 32.

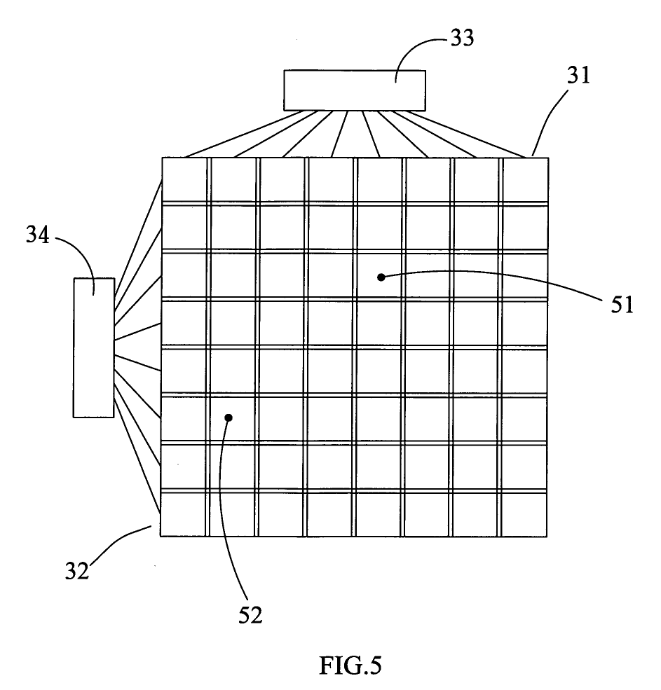

Referring to FIG. 5, a schematic diagram of a first embodiment of the disclosed resistive multi-touch panel is provided. In the present embodiment, two force sources applied to the touch points 51 and 52 are accurately exerted to areas composed of the first planar resistors 311 and the second planar resistors 321 so that positions of the touch points 51 and 52 are accurately detected from the first touch sensing device 33 and the second touch sensing device 34.

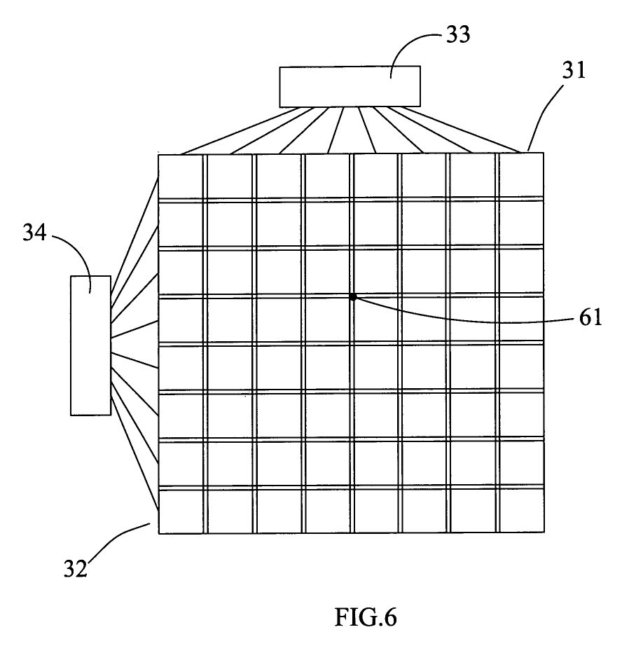

In FIG. 6, a schematic diagram of a second embodiment of the disclosed resistive multi-touch panel is provided. In the present embodiment, a force source applied to a touch point 61 is exerted between two of the first planar resistors 311 and two of the second planar resistors 321. Thus, a voltage variation of the first planar resistors 311 and the second planar resistors 321 resulted from the touch point 61 differs from the area. At this time, the first touch sensing device 33 and the second touch sensing device 34 can still determine the position of the touch point 61 by the difference between the voltage variations without determining the single touch point as two different touch points. Alternatively, a margin of the touch point can be set so that positions within the margin are determined as a single touch point.

Although the particular embodiments of the invention have been described in detail for purposes of illustration, it will be understood by one of ordinary skill in the art that numerous variations will be possible to the disclosed embodiments without going outside the scope of the invention as disclosed in the claims.

What is claimed is:

1. A resistive multi-touch panel, comprising:
a first touch panel module having a plurality of first planar resistors independently arranged;
a second touch panel module having a plurality of second planar resistors independently arranged, wherein the second touch panel module is positioned below the first touch panel module while an arrangement direction of the second planar resistors differs from an arrangement direction of the first planar resistors;
at least one touch sensing device for detecting at least one touch point between the first touch panel module and the second touch panel module to output at least one first touch signal according to a variation of at least one of the first planar resistors and output at least one second touch signal according to a variation of at least one the second planar resistors; and
at least one coordinate acquiring device for outputting a position corresponding to the touch point according to the first touch signal and the second touch signal that are mutually corresponding.

2. The resistive multi-touch panel of claim 1, wherein the first touch panel module and the second touch panel module are arranged as perpendicular to each other.

3. The resistive multi-touch panel of claim 1, wherein each of the first planar resistors of the first touch panel module has a constant external voltage.

4. The resistive multi-touch panel of claim 1, wherein each of the second planar resistors of the second touch panel module has a constant external voltage.

5. The resistive multi-touch panel of claim 1, wherein the touch sensing device further comprises a determining mechanism for determining whether the touch point is effective.

6. The resistive multi-touch panel of claim 1, wherein the position is directly outputted by taking the first touch panel module as a coordinate.

7. The resistive multi-touch panel of claim 1, wherein the position is outputted by converting a coordinate of the first planar resistors into a coordinate of the first touch panel module.

8. The resistive multi-touch panel of claim 1, wherein the position is directly outputted by taking the second touch panel module as a coordinate.

9. The resistive multi-touch panel of claim 1, wherein the position is outputted by converting a coordinate of the second planar resistors into a coordinate of the second touch panel module.

10. The resistive multi-touch panel of claim 1, wherein the variation of the first planar resistor or the second planar resistor is a voltage variation.

11. A detecting method of a resistive multi-touch panel, comprising:
providing a first touch panel module having a plurality of first planar resistors independently arranged;
providing a second touch panel module having a plurality of second planar resistors independently arranged, wherein the second touch panel module is positioned below the first touch panel module while an arrangement direction of the second planar resistors differs from an arrangement direction of the first planar resistors;
providing at least one external force to form at least one touch point between the first touch panel module and the second touch panel module;
detecting a variation of at least one of the first planar resistors at the at least one touch point to output at least one first touch signal;
detecting a variation of at least one of the second planar resistors at the at least one touch point to output at least one second touch signal; and
outputting a position corresponding to the touch point according to the first touch signal and the second touch signal that are mutually corresponding.

12. The detecting method of claim 11, wherein the first touch panel module and the second touch panel module are arranged as perpendicular to each other.

13. The detecting method of claim 11, wherein each of the first planar resistors of the first touch panel module has a constant external voltage.

14. The detecting method of claim 11, wherein each of the second planar resistors of the second touch panel module has a constant external voltage.

15. The detecting method of claim 11, wherein the first touch signal or the second touch signal is outputted by at least one touch sensing device.

16. The detecting method of claim 15, wherein the touch sensing device further comprises a determining mechanism for determining whether the touch point is effective.

17. The detecting method of claim 11, wherein the position is outputted by at least one coordinate acquiring device.

18. The detecting method of claim 11, wherein the position is directly outputted by taking the first touch panel module as a coordinate.

19. The detecting method of claim 11, wherein the position is outputed by converting a coordinate of the first planar resistors into a coordinate of the first touch panel module.

20. The detecting method of claim 11, wherein the position is directly outputted by taking the second touch panel module as a coordinate.

21. The detecting method of claim 11, wherein the position is outputted by converting a coordinate of the second planar resistors into a coordinate of the second touch panel module.
